(19) United States
(12) Patent Application Publication
(10) Pub. No.: US 2014/0272427 A1
(43) Pub. Date: Sep. 18, 2014

(54) Reinforced Composites And Methods Of Manufacturing The Same

(71) Applicant: David Engelke, Ft. Lauderdale, FL (US)

(72) Inventor: Dominic A. Paratore, Manchester, MA (US)

(21) Appl. No.: 14/211,088

(22) Filed: Mar. 14, 2014

Related U.S. Application Data
(60) Provisional application No. 61/783,216, filed on Mar. 14, 2013.

(51) Int. Cl. B29C 70/28; B32B 17/10; B29C 47/06

(52) U.S. Cl. CPC B29C 70/28; B29C 47/06; B32B 17/10
USPC 428/426; 264/173.16

(57) ABSTRACT

Reinforced composites and methods of manufacturing the same are described. According to one aspect, the composite materials may include one or more pre-impregnated materials (“pre-pregs”) as a reinforcing component and a thermoplastic resin body having structural features. The pre-pregs may include fibers mixed with one or more binding materials. At least one of the one or more binding materials of the pre-preg is the same as or otherwise configured to melt and/or flow together with the material of the thermoplastic resin body so as to bond and/or comingle with the thermoplastic resin body to form a homogenous or near homogenous composite body. The one or more pre-pregs may be introduced to a melt stream of the thermoplastic resin body such to form a substantially integral composite through a continuous fabrication process.

### CROSS-REFERENCE TO RELATED APPLICATION

This application claims the benefit of U.S. Provisional Patent Application No. 61/783,216, filed on Mar. 14, 2013, the content of which is incorporated herein by reference in its entirety.

### FIELD OF THE TECHNOLOGY

Embodiments of the present subject matter relate to reinforced composites and methods of manufacturing such composites.

### BACKGROUND

Conventional structural components (e.g., storage containers, construction modular units, flooring, fencing, vehicle components, doors, panels, or the like) have been formed of wood (e.g., plywood), cored metal sheets, plastics and/or wood skins. As cost and scarcity of these traditional materials increases, and recognizing that such materials lack durability and are also difficult to clean and repair, composite materials have become increasingly more attractive for use in construction and/or for forming such various structural components. Fiber-reinforced composite materials have become a particularly attractive alternative to traditional materials due to their strength and light weight.

Fiber-reinforced composites typically refer to materials having one or more fibers combined with one or more binding materials, such that the combination of one or more fibers and one or more binding materials form a fiber-reinforced composite that is stronger than the one or more binding materials alone. Fiber-reinforced composites may be formed as pre-impregnated composites (also known as “pre-pregs”), the term “pre-impregnated” referring to the fact that the one or more fiber materials (e.g., in the form of a weave) are impregnated with the one or more binding materials before final curing. These fiber-reinforced composites or pre-impregnated composites are utilized, for example, as structural components used in construction of storage units, commercial buildings, boats, vehicles, and/or housing structures. However, for aesthetic and durability purposes, the structural performance of traditional fiber-reinforced composites has been limited due to high raw materials costs, high manufacturing costs, and the physical properties of the binding materials, fillers, and/or fiber additives.

Conventional fiber-reinforced composites have been manufactured using a thermoplastic extrusion process involving sprinkling or mixing glass fibers into a thermoplastic melt stream to strengthen a final extruded thermoplastic body. The reinforcing strength contributed by the glass fibers however is limited to the length of the small glass fibers. Fiber-reinforced composites have also been traditionally manufactured using compression molding, wherein a sheet of glass fibers (i.e., a fiberglass sheet) is pressed against and adhered to a thermoplastic sheet using some type of glue. Disadvantages associated with this method, however, include the sheet of glass fibers peeling away from the core thermoplastic sheet and costly manufacturing.

### SUMMARY

According to one aspect of the disclosed subject matter, a composite body and method for the manufacturing the same are described. Some method embodiments may include introducing a unidirectional, glass-reinforced, pre-impregnated material into the melt stream of an extrusion process for manufacturing a composite body, wherein the core of the composite body may include one or more thermoplastic materials.

Some embodiments of the present disclosure may include introducing one or more thermoplastic resins into an extruder having at least one or more inlet zones and/or at least one combining zone where one or more pre-impregnated polymers (e.g., thermoplastic(s) and/or thermoset(s)) may be combined with the one or more thermoplastic resins under conditions of sufficient pressure and temperature to cause at least one of the one or more pre-impregnated thermoplastics to bond or comingle with at least one of the one or more thermoplastic resins causing the at least one of the one or more thermoplastic resins and the at least one of the one or more pre-impregnated polymers to form a homogeneous or near homogenous composite body. Some method embodiments may include extruding the homogeneous or near homogenous composite body through a sizing die and/or a downstream sizing station to provide a final size and shape of the homogeneous or near homogenous composite body.

Method embodiments of the disclosed subject matter may include methods for manufacturing a reinforced composite body that include melting a thermoplastic resin (e.g., thermoplastic pellets, flake, regrind or any other suitable form) to form a melt stream, extruding the melt stream of thermoplastic resin through one or more dies or a sizing station to form a thermoplastic resin body of a specific profile and introducing one or more pre-impregnated materials to such thermoplastic resin body such that the one or more pre-impregnated materials melt and/or flow with the thermoplastic resin body and cause the one or more pre-impregnated materials to bond or comingle with the thermoplastic resin body, wherein the one or more pre-impregnated materials may include at least one binding material and a plurality of reinforcing fibers. In some embodiments the at least one binding material may be the same material as the thermoplastic resin body (i.e., the same thermoplastic resin) or a similar material (i.e., a different thermoplastic resin or other material, but having properties or chemical structure or composition similar to the thermoplastic resin body), such that the one or more pre-impregnated materials and the thermoplastic resin body form a homogenous or near homogenous composite body reinforced by the plurality of reinforcing fibers within the one or more pre-impregnated materials.

According to another aspect of the subject matter of the present disclosure, a reinforced composite is described. The reinforced composite according to some embodiments may include a core component having one or more structural features and a pre-impregnated material comprising one or more binding materials and a plurality of fibers, wherein the pre-impregnated material and the core component may together form a homogenous or substantially homogenous reinforced composite.

### BRIEF DESCRIPTION OF THE DRAWINGS

Aspects and embodiments of the present disclosure will be described with reference to the following figures. It should be appreciated that the figures are not necessarily drawn to scale. Items appearing in multiple figures are indicated by the same reference number in all the figures in which they appear.

FIG. 1 illustrates a flowchart of a method of manufacturing a reinforced composite according to some embodiments.

FIG. 2 illustrates a flowchart of another method of manufacturing a reinforced composite according to some embodiments.

FIG. 3A illustrates a top view of a pre-impregnated body according to some embodiments.

FIG. 3B illustrates a cross-section of the pre-impregnated body shown in FIG. 3A according to some embodiments.

FIG. 3C illustrates a top view of a thermoplastic resin according to some embodiments.

FIG. 3D illustrates a cross-section of the thermoplastic resin shown in FIG. 3C according to some embodiments.

FIG. 4A illustrates an example of a reinforced composite prior to a curing and/or hardening process according to some embodiments.

FIG. 4B illustrates the reinforced composite shown in FIG. 4A following a curing and/or hardening process according to some embodiments.

FIG. 5A illustrates another example of a reinforced composite prior to a curing and/or hardening process according to some embodiments.

FIG. 5B illustrates the reinforced composite shown in FIG. 5A following a curing and/or hardening process according to some embodiments.

FIGS. 6A-6C illustrate surface views of pre-impregnated bodies of a composite having different fiber orientations according to some embodiments.

FIG. 7A illustrates another example of a reinforced composite prior to a curing and/or hardening process according to some embodiments.

FIG. 7B illustrates the reinforced composite shown in FIG. 7A following a curing and/or hardening process according to some embodiments.

### DETAILED DESCRIPTION OF EMBODIMENTS

Reinforced composites and methods of manufacturing the same are disclosed. The reinforced composites may include one or more pre-impregnated bodies (e.g., sheets, films, or tapes) combined with a core component of one or more thermoplastic resins. A pre-impregnated body (e.g., a sheet, film, or tape) (hereinafter “pre-preg”) may include one or more binding materials, such as a thermoset resin (e.g., epoxy) or a thermoplastic resin, and one or more fiber materials (e.g., glass). The core component of one or more thermoplastic resin(s) may include one or more materials that are the same as at least one of the one or more binding materials of the one or more pre-pregs (i.e., the same thermoplastic resin) or similar to at least one of the one or more binding materials of the one or more pre-pregs (i.e., a different thermoplastic resin or other material, but having properties or chemical structure or composition similar to the thermoplastic resin body).

For example in some embodiments at least one of the one or more pre-pregs may include a binding material of thermoplastic resin that is the same thermoplastic resin as the thermoplastic resin of the core component. In some embodiments at least one of the one or more pre-pregs may include a thermoplastic resin binding material that is different, but similar to, the thermoplastic resin of the core component. Some embodiments may involve using pre-pregs comprising materials different from a thermoplastic resin as long as such materials melt and flow together with the thermoplastic resin of the core component so as to bond or comingle with the thermoplastic resin of the core component and form a homogenous or near homogenous structure.

In some embodiments, one or more pre-pregs and the core component may be joined or combined using a continuous extrusion (i.e., “co-extrusion”) process to produce a reinforced composite body. In some embodiments the reinforced composite body may be in the form of a sheet. Embodiments of the present disclosure also include the reinforced composite body being formed into any other desired profile, shape or configuration.

Joining or combining the one or more pre-pregs and core component of thermoplastic resin(s) using co-extrusion provides for the one or more pre-pregs to serve as a reinforcing component to the core component of thermoplastic resin(s) and/or of the reinforced composite body itself. By using one or more pre-pregs having binding material(s) that are the same as or similar to the material of the core component (e.g., thermoplastic resin) such that the binding material(s) and core component material melt and flow together so as to bond or comingle and form a homogenous or near homogenous composite structure, it becomes unnecessary to wet (i.e., soak or saturate) or re-wet (i.e., re-soak or re-saturate) the one or more fiber materials of the pre-preg with the thermoplastic resin(s) of the core component in order to bond the one or more fiber materials with the core component because such one or more fiber materials are already wetted within the one or more binding materials of the one or more pre-pregs. In other words, because the one or more fiber materials are wetted within the one or more pre-pregs, and the one or more pre-pregs are joined or combined with the core component of thermoplastic resin(s) by way of the one or more binding materials of the one or more pre-pregs, the one or more fiber materials become joined or combined with the core component to form a composite thermoplastic resin body that is reinforced by those one or more fiber materials.

FIG. 1 illustrates a flowchart for a method 100 of manufacturing a reinforced composite according to some embodiments of the present disclosure. The method 100 may include softening or melting one or more thermoplastic resins (e.g., pellets or another appropriate form) to provide a melt stream as indicated in block 102. The melt stream of one or more thermoplastic resins may be soft, viscous or liquid in form. The one or more thermoplastic resins may be heated prior to and/or during a co-extrusion process to an appropriate temperature, for example, in the range of about 150° F. to about 500° F. by application of heat, shear force and/or pressure. The thermoplastic resins may be composed of a resin or resin alloy of polypropylene (PP), high-density polyethylene (HDPE), polyvinyl chloride (PVC), polyethylene terephthalate (PET), Nylon and/or other polymers. In some embodiments the thermoplastic resins may include one or more polymers mixed with rice hulls, wheat, wood fiber, wood flour or any other suitable organic material, or any suitable nonorganic mineral material, including without limitation talc or calcium carbonate. The thermoplastic resin(s) may include organic and/or inorganic fillers, binders, and/or additives. Other materials may also be suitable, particularly those which are dispersible within one or more binding materials of any pre-preg so as to bond and/or comingle with the one or more binding materials when such one or more binding materials are joined or combined with the melt stream of thermoplastic resin(s).

The thermoplastic resin(s) may include virgin resin, an alloy of multiple resins, mineral fillers, organic fillers, reground material, scrap material, foam material, blowing agents, coupling agents, colorants or other material additives. In some embodiments the thermoplastic resin(s) may be utilized as the core component of the reinforced composite bodies of the present disclosure. The thermoplastic resin(s) may have any number of profiles, shapes or configurations prior to being melted, including without limitation, thermoplastic pellets.

Method 100 may further include introducing one or more pre-pregs (e.g., one or more thermoplastic-based pre-pregs) to the melt stream of one or more thermoplastic resins as indicated in block 104. The one or more pre-pregs may be in the form of a sheet, film, tape, or any other suitable profile, shape or configuration that achieves the objectives of the present disclosure. The one or more pre-pregs may include one or more binding materials that serve as a matrix that wets and bonds together one or more fiber materials (e.g., glass fibers) of the one or more pre-pregs. In some embodiments, the one or more binding materials may include one or more thermoplastic resins. In some embodiments the one or more fiber materials may include glass fibers, carbon fibers, Kevlar fibers, graphite fibers, and/or polyester fibers. The one or more fiber materials may be woven fabric and/or unwoven and mixed with one or more binding materials when forming the pre-preg such that the one or more fiber materials are substantially wetted by the one or more binding materials. The one or more pre-pregs may include in some embodiments one or more thermoplastic-based binding materials that are pre-impregnated with a plurality of glass fibers. In some embodiments the one or more pre-pregs may include one or more thermoplastic-based binding materials that are pre-impregnated with a plurality of organic fibers or polymer fibers.

In some embodiments the one or more pre-pregs may include or consist entirely of one or more binding materials of one or more thermoset or thermosetting polymers, such as for example, but without limitation, epoxy. These thermoset or thermosetting polymers, in a manner similar to as described above with respect to embodiments involving thermoplastic binding materials, may be impregnate a plurality of glass fibers, organic fibers and/or polymer fibers to form a pre-preg including or consisting entirely of one or more thermoset or thermosetting polymers. The one or more binding materials of the one or more pre-pregs may be any material that melts or flows together with the core component according to embodiments of the present disclosure (e.g., during a co-extrusion process) so as to cause the one or more binding materials and the core component to bond or comingle to form a homogenous or near-homogeneous composite body.

In some embodiments, the one or more binding materials of the one or more pre-pregs may be softened and/or melted during a manufacturing process (e.g., co-extrusion) upon coming into contact with the melt stream of the thermoplastic resin(s). In some embodiments, the one or more binding materials of the one or more pre-pregs may be formed of the same thermoplastic resin(s) as the thermoplastic resin of the melt stream, such that co-extrusion of the one or more pre-pregs and the thermoplastic resin forms a monolithic thermoplastic composite body reinforced with the one or more fiber materials of the one or more pre-pregs. In this manner, the pre-preg is utilized as a reinforcing component of the composite. Advantageously, by using one or more pre-pregs, it becomes unnecessary to wet (i.e., soak or saturate) or re-wet (i.e., re-soak or re-saturate) the one or more fiber materials of the one or more pre-pregs with the thermoplastic resin(s) of the melt stream to bond the one or more fiber materials with the thermoplastic resin(s) of the melt stream because the one or more fiber materials of the one or more pre-pregs are already wetted within the binding material of the one or more pre-pregs.

In some embodiments, a two or more pre-pregs may be introduced to the melt stream of thermoplastic resin(s). A first pre-preg may be introduced to one portion (e.g., top) of the melt stream of thermoplastic resin(s) while a second pre-preg may be introduced to another portion (e.g., the bottom) of the melt stream of thermoplastic resin(s) to provide reinforcement along the two portions (e.g., on the top and bottom) of the melt stream of thermoplastic resin(s). The first and second pre-pregs, in some embodiments, may be introduced to the melt stream of thermoplastic resin(s) substantially simultaneously such that each pre-preg melts and/or flows together with the melt stream of the thermoplastic resin(s) in a continuous process so as to bond and/or comingle with the melt stream of thermoplastic resin(s). As a result of this continuous process a composite body of thermoplastic resin(s) reinforced with a first pre-preg (e.g., along a top portion) and a second pre-preg (e.g., along a bottom portion) is formed. An example of such a reinforced composite body including a first and second pre-preg is shown in FIGS. 7A and 7B and described in further detail below.

As indicated in block 106, the method 100 may also include co-extruding the combined melt stream of thermoplastic resin(s) and the one or more pre-pregs before and/or during the forming (e.g., curing or hardening) process of a reinforced composite body. The process of co-extruding the combined melt stream of thermoplastic resin(s) and the one or more pre-pregs may include forcing (e.g., pushing or pulling) the combination through one or more dies having desired profiles, shapes or configurations. The one or more dies may be formed such that one or more fiber materials of the one or more pre-pregs remain substantially unexposed while passing through the one or more dies while still residing on the extreme surfaces (top and/or bottom) of the combined melt stream of thermoplastic resin(s) and one or more pre-pregs. In some embodiments the one or more dies may be formed such that substantially all of the fiber materials of the one or more pre-pregs remain substantially unexposed while passing through the one or more dies.

According to some embodiments of the present disclosure, applying pressure and/or heat to a portion of a pre-preg during the co-extrusion process may cause that portion and/or surrounding portions of the pre-preg to melt and/or substantially soften. In some embodiments, or additionally, portions or substantially all of the pre-preg will melt or substantially soften upon contacting the melt stream of thermoplastic resin(s). The elevated temperature of the melt stream of thermoplastic resin(s) and/or additional pressure applied during the co-extrusion process may cause, according to some embodiments, a pre-preg to melt and/or substantially soften down to or near the point of thermoplastic flow of the melt stream of thermoplastic resin(s). In some embodiments, a pre-preg may also be heated by application of an external heat source, such that a portion of the pre-preg (e.g., at the surface of the pre-preg) and/or the entire pre-preg is heated to a particular temperature. The combination of an external heat source and the heat of the melt stream of thermoplastic resin(s) and/or the pressure applied during the co-extrusion process may result in a pre-preg and a melt stream of thermoplastic resin(s) co-mingling and/or bonding. The melt stream of thermoplastic resin(s) and the pre-preg may bond and/or co-mingle and form a homogeneous or near homogeneous material at the surface.

In some embodiments, a plurality of melt streams (e.g., of thermoplastic resins) may be introduced to the external surface of a reinforced composite body formed from one or more thermoplastic resin core components and one or more pre-pregs to form a reinforced composite body having multiple players of thermoplastic resin(s). For example, a plurality of melt streams of thermoplastic resin(s) may form an outer skin or shell of a reinforced composite body. In some embodiments, the plurality of melt streams of thermoplastic resin(s) may be extruded through one or more separate dies and/or may be coextruded with the one or more pre-pregs and thermoplastic resin core component(s) of the reinforced composite body. The plurality of melt streams of thermoplastic resin(s) may be introduced to one or more surfaces of one or more pre-pregs of the reinforced composite body. The plurality of melt streams of thermoplastic resin(s) may be introduced substantially simultaneously during a co-extrusion process of forming the reinforced composite body of one or more pre-pregs and the thermoplastic resin core component(s). An example of an embodiment including a plurality of thermoplastic resin layers at the external surfaces of a reinforced composite body, as described directly above, is shown in FIGS. 7A and 7B.

In some embodiments, rolls and/or other mechanisms may be utilized during the curing or hardening process following the co-extrusion. As a result, the bond between the one or more binding materials of the one or more pre-pregs and the melt stream of thermoplastic resin(s), as well as any additional layers of thermoplastic resin (e.g., as shown in FIGS. 7A and 7B) is formed to provide a composite body having one or more components reinforced by the one or more fibers of the one or more pre-pregs.

Advantageously, as a result of the process described above with respect to FIG. 1, and also as otherwise described throughout the present disclosure, such reinforced composite bodies described herein and according to the disclosed subject matter, can be manufactured more cost-effectively. Unlike conventional methods for manufacturing composite products that involve melting a prefabricated body (e.g., a sheet) of material, moving such body into a press, laying a skin material on such body within the press and then applying heat and/or pressure thereto, the processes provided herein begin with raw materials (e.g., thermoplastic pellets) and form a reinforced composite body by combining such raw material (e.g., in melted or substantially softened form) with one or more pre-pregs. Accordingly the methods of the present disclosure eliminate the costly step of using (and melting) a prefabricated body (e.g., sheet) of material. Moreover using raw materials (e.g., thermoplastic resin pellets) also provides flexibility in forming various profiles, shapes and configurations.

FIG. 2 illustrates a flowchart of another method 200 of manufacturing a reinforced composite according to some embodiments. The method 200 may include melting one or more thermoplastic resins (e.g., pellets) to form a melt stream as indicated in block 202 similar to the method 100 described above with reference to block 102. The method 200 may further include extruding the thermoplastic resin melt stream through a die as indicated in block 204 to form a particular structural geometry (e.g., a sheet). Unlike the method 100 discussed above, the method 200 includes extruding the melt stream of the thermoplastic resin(s) without the pre-preg. The extruded thermoplastic resin melt stream (i.e., the “extrudate”) may form the structural component (i.e., core component) of the reinforced composite body having a profile and/or pattern corresponding to the die through which the melt stream was forced. As indicated in block 206, the method 200 includes introducing one or more pre-pregs to the extrudate. Similar to the melt stream discussed above with reference to method 100, when using one or more thermoplastic-based pre-pregs, such as a thermoplastic resin that is impregnated with glass fibers, the elevated temperature of the extrudate will cause the resin in the pre-preg(s) to melt, cure, and form a bond with the extrudate. In some embodiments, the pre-preg(s) may also be heated by application of an external heat source, such that a portion of the pre-preg (e.g., at the surface of the pre-preg) and/or the entire pre-preg is heated to a particular temperature. The combination of an external heat source and the heat of the extrudate may result in the pre-preg and the melt stream co-mingling and/or bonding. In some embodiments, the pre-preg can be brought into contact with the extrudate and held in place by rollers, pressure, a vacuum or other suitable methods, while the resin in the pre-preg is held at an appropriate temperature and pressure to cause a bond to occur between the extrudate and the pre-preg.

In some embodiments, a plurality of pre-pregs may be introduced to the extrudate. For example, a first pre-preg may be introduced to one side of the extrudate while a second pre-preg may be introduced to another side of the extrudate to provide reinforcement on multiple sides of the extrudate. The plurality of pre-pregs may be introduced substantially simultaneously to the extrudate such that they co-mingle and/or bond with the extrudate in a continuous process. Similar to the embodiments discussed above with reference to FIG. 1, in some embodiments, a plurality of melt streams of thermoplastic resin(s) may also be introduced to the external surface of a composite body manufactured in accordance with one or more methods described above with respect to FIG. 2. For example, a plurality of thermoplastic melt streams may form an outer skin or shell of such composite. In some embodiments, the plurality of thermoplastic melt streams may be extruded through a separate die and/or may be co-extruded with the thermoplastic melt stream that forms the extrudate. In some embodiments the plurality of thermoplastic melt streams may be introduced to the surfaces of a plurality of pre-preg materials in the composite body. The plurality of thermoplastic melt streams may be introduced substantially simultaneously during a continuous process of forming other layers of the composite body. An example of an embodiment including a plurality of pre-pregs and/or a plurality of thermoplastic resin layers at the external surfaces of the composite body is shown and described with reference to FIGS. 7A-7B below.

FIG. 3A illustrates a top view of a pre-preg 300 according to some embodiments. FIG. 3B illustrates a cross-section of the pre-preg shown in FIG. 3A. As discussed above, the pre-preg 300 may include one or more binding materials 302 composed of thermoset (e.g., epoxy) and/or thermoplastic resin, and one or more fiber materials 304 mixed with the one or more binding materials 302. The one or more binding materials 302 may be mixed with the one or more fiber materials 304 such that the one or more fiber materials 304 are substantially covered (e.g., “wetted”) by the one or more binding materials 302. The one or more fiber materials 304 may provide structural reinforcement to the pre-preg 300 based on an orientation of the one or more fiber materials 304, as will be discussed in greater detail below with reference to FIGS. 6A-6C. As discussed above, the pre-preg 300 may be a reinforcing component of a manufactured composite material.

FIG. 3C illustrates a top view of a thermoplastic resin body 306 according to some embodiments. FIG. 3D illustrates a cross-section of a thermoplastic resin body 306 shown in FIG. 3C. As shown in FIGS. 3C and 3D, unlike the pre-preg 300, the thermoplastic resin body 306 does not contain reinforcing fibers. As discussed above, the thermoplastic resin body 306 is a structural component (i.e., core component) of the manufactured composite material. The material of the thermoplastic resin body 306 may be the same as, similar to and/or otherwise melt or flow together with the one or more binding materials 302 of the pre-preg 300 such that bonding and/or comingling may occur between the pre-preg 300 and the thermoplastic resin body 306 to form an integral or substantially integral reinforced composite body. In some embodiments, the one or more binding materials 302 may be formed of a thermoplastic resin having the same properties as the thermoplastic resin body 306.

FIG. 4A illustrates an example of a reinforced composite 401 prior to hardening according to some embodiments. As shown in FIG. 4A, the reinforced composite 401 includes a patterned thermoplastic resin body 406 having structural features 410. The structural features 410 may be produced by extruding the thermoplastic resin body 406 through a die having a pattern corresponding to the structural features 410. For example, the die may include obstructions in areas corresponding to structural features 410, such that, as the thermoplastic resin body 406 is forced through the die, the structural features 410 (e.g., through-holes) are formed in the thermoplastic resin body 406.

The reinforced composite 401 may also include at least one pre-preg 400 having one or more binding materials 402 and reinforcing fibers 404. The one or more binding materials 402 may be composed of any one or more materials that melt and/or flow together with thermoplastic resin sheet 406 so as to bond and/or comingle with thermoplastic resin sheet 406 to form a homogenous or near homogenous composite body. For example, at least one of the one or more binding materials 402 may be formed of the same thermoplastic resin as the thermoplastic resin body 406. As discussed above with reference to FIGS. 1 and 2, the thermoplastic resin body 406 may be applied to the pre-preg 400 as a melt stream through the application of heat and/or extrusion. Due to the heat and/or pressure at the interface of the thermoplastic resin body 406 and the pre-preg 400, a portion 408 of the pre-preg 400 melts, co-mingles, and/or bonds with the thermoplastic resin body 406.

FIG. 4B illustrates the reinforced composite 401 shown in FIG. 4A following a curing and/or hardening process. As shown in FIG. 4B, following a curing and/or hardening process, the portion 408 hardens and/or cures such that pre-preg 400 becomes substantially integral with the thermoplastic resin body 406.

The pre-preg 400 may be utilized as reinforcement for the thermoplastic resin body 406 including one or more structural features, as discussed above. The amount of reinforcement can be varied in density, weight, or direction along the cross-section of the thermoplastic resin body 406 to optimize the structural properties of the reinforced composite body resulting from the co-extrusion. For example, the pre-preg may be introduced in any portion of the cross-section of the thermoplastic resin body 406 for reinforcement through variation of process parameters. In some embodiments, plural thermoplastic resin melt streams may be formed and combined with the pre-preg. The plural melt streams may be formed by melting and/or extruding plural thermoplastic resin bodies. The plural melt streams may be applied to the pre-preg following extrusion and/or may be co-extruded with the pre-preg by utilizing a die having an appropriate profile corresponding to the combined structure.

FIG. 5A illustrates another example of a reinforced composite 501 prior to hardening according to some embodiments. As shown in FIG. 5A, the reinforced composite 501 includes a first thermoplastic resin body 506A and a second thermoplastic resin body 506B. The thermoplastic resin body 506A may include structural features 510A, while the thermoplastic resin body 506B may include structural features 510B that are different than the structural features 510A. In some embodiments, the structural features 510A and 510B may be the same. In some embodiments, structural features may be included in only one of the thermoplastic resin bodies 560A or 506B. These and other variations may also be formed based on adjustment of processing components, such as an extrusion die profile.

A pre-preg 500 is formed between the thermoplastic resin bodies 506A and 506B. The pre-preg 500 includes one or more fiber materials 504 and one or more binding materials 502 that are the same as, similar to or melt and/or flow together with the material(s) of the thermoplastic resin bodies 506A and 506B such that bonding and/or comingling occurs between the materials 502 and 506A and 506B to form a homogenous or near homogenous composite body. More specifically due to heat and/or pressure applied during the process, portions 508A and 508B of the pre-preg 500 melts, co-mingles, and/or bonds at the interfaces of the pre-preg 500 and the thermoplastic resin bodies 506A and 506B.

FIG. 5B illustrates the reinforced composite 501 shown in FIG. 5A following a curing and/or hardening process. As shown in FIG. 5B, following a curing and/or hardening process, the portions 508A and 508B harden and/or cure such that pre-preg 500 becomes substantially integral with the thermoplastic resin bodies 506A and 506B.

The pre-preg 500 in any of the embodiments described above may be combined with the thermoplastic resin bodies 506A and 506B including the structural features in order to provide a desired reinforcement and/or bending strength for a final reinforced composite body. In some embodiments, the pre-preg 500 may be combined with sections of the thermoplastic resin bodies 506A and 506B in order to provide reinforcement in some areas of the reinforced composite body without providing reinforcement to other areas of the reinforced composite body. In some embodiments, the pre-preg may 500 have differently-oriented fibers in order to provide different reinforcement properties in forming composite materials. FIGS. 6A-6C illustrate surface views of a pre-preg 600A, 600B and 600C of a reinforced composite body having different fiber orientations according to some embodiments of the present disclosure. The pre-preg 600A shown in FIG. 6A includes fibers 604 that are unidirectionally oriented. The unidirectionally-oriented fibers 604 shown in FIG. 6A may be introduced in any orientation to a thermoplastic resin body to form a reinforced composite in order to provide the desired structural reinforcement and/or bending strength to the reinforced composite body. As a result, the pre-preg can be positioned in the process to create a structural extrusion that can be tailored to provide the desired structural design features. The structural features, as well as the fibers of the pre-preg, can be oriented in the linear direction of the extrusion or at any other direction (e.g., at any angle in a range of 0 degrees to 90 degrees) to give the desired structural results.

FIGS. 6B and FIG. 6C illustrate pre-pregs 600B and 600C that include one or more fiber materials 604 having different relative orientations. For example, as shown in FIG. 6B, one or more fiber materials 604 are substantially orthogonal to one another in the pre-preg 600B. Additionally and/or alternatively, as shown in FIG. 6C, the one or more fibers 604 are oriented at an offset of about 45 degrees to one another. While not shown, other orientations (e.g., at any angle between 0 and 90 degrees) may be utilized for the one or more fiber materials 604 included in the pre-preg. The fibers 604 shown in FIGS. 6B and 6C may be woven and/or unwoven fibers having different orientations. In some embodiments, a plurality of pre-pregs having different fiber orientations may be combined (e.g., bonded with one another by melting a common material, laminated, or the like) in order to form a pre-preg having variations in fiber orientation.

FIG. 7A illustrates another example of a reinforced composite 701 prior to hardening according to some embodiments. As shown in FIG. 7A, the reinforced composite 701 includes a first thermoplastic resin body 706A. The thermoplastic resin body 706A may include structural features 710. A pre-preg 700A and 700B is formed on opposing surfaces of the thermoplastic resin body 706A. The pre-pregs 700A and 700B include one or more fiber materials 704 and one or more binding materials 702 that are the same as, similar to and/or melt and/or flow together with the material(s) of the thermoplastic resin body 706A such that bonding and/or comingling occur between the materials 702 and 706A. More specifically due to heat and/or pressure applied during the process, portions 708A and 708B of the pre-pregs 700A and 700B melts, co-mingles, and/or bonds at the interfaces of the pre-pregs 700A and 700B and the thermoplastic resin body 706A. In some embodiments, plural thermoplastic resin bodies and/or melt streams may be introduced during the process in order to provide an outer thermoplastic layer (e.g., skin and/or protective layer). For example, as shown in FIG. 7A, thermoplastic resin sheets 706A and 706B may be included in the reinforced composite body. The thermoplastic resin bodies 706B and 706C may be introduced during a continuous fabrication process as thermoplastic melt streams. Due to heat and/or pressure applied during the process, portions 708C and 708D of the pre-pregs 700A and 700B melts, co-mingles, and/or bonds at the interfaces of the pre-pregs 700A and 700B and the thermoplastic resin bodies 706B and 706C.

FIG. 7B illustrates the reinforced composite 701 shown in FIG. 7A following a curing and/or hardening process. As shown in FIG. 7B, following a curing and/or hardening process, the portions 708A-708D harden and/or cure such that pre-pregs 700A and 700B become substantially integral with the thermoplastic resin bodies 706A, 706B and 706C. As described above, a reinforced composite body may be formed in a continuous process without having to wet, re-wet and/or re-bond the fibers of a pre-preg material with one or more binding materials. In some embodiments, the method of manufacturing the composite may be implemented by utilizing an extrusion system that is typically utilized for the production of sandwich panels. For example, the method may be implemented by utilizing a modified extrusion system that is utilized in manufacturing extruded cores and applied decorative film coverings. These machines may also be utilized for co-extrusion of multiple materials through multiple extrusion units where the melt streams of each extruder are merged into a singular product.

In some embodiments, the machine die head and downstream sizing equipment may be modified to incorporate the pre-preg material into the melt stream. The extruder die and downstream equipment may be further modified to enable the presentation of the pre-preg in a unidirectional, 90 degree, or other orientation to the thermoplastic resin melt stream(s). In some embodiments, the extruder die and downstream equipment may be modified to position the depth that the pre-preg is located in the cross-section of the thermoplastic resin melt stream, extrudate and/or reinforced composite body. The pre-preg can be located in one or multiple layers at one or multiple positions through the thermoplastic resin melt stream, extrudate and/or reinforced composite body cross-section as discussed above.

The reinforced composite body and method of making the same as described herein enables the inclusion of high performance structural reinforcing glass or other high-strength fibers into the linear extrusion process in an oriented fiber direction. As discussed above, a secondary bonding process is not required to bond the reinforced material (e.g., pre-preg) to the surface of the extrusion, since the heat and/or pressure applied during the formation of the structural features in the extrudate are utilized to bond the pre-preg as the reinforcing material. The reinforcing material can be positioned anywhere in the cross-section area of the profile so as to maximize the structural benefit of the material.

As discussed above, a continuous process may be utilized to form the reinforced composite body. Examples of discontinuous processes include introducing fiber reinforcement into a plastic resin by mixing before extrusion into a pellet format, introducing fiber reinforcement into a plastic material during the extrusion process through various material feed systems by metering fibers into the melt stream of the extruder, laminating reinforced sheets or preforms to the surface of the extruded sheet, mixing materials to create plastic alloys to alter the properties of the mixed material, mechanically bonding reinforcement to the exterior surface of the product, and/or modifying the shape of the extrusion. Discontinuous processes (e.g., lamination and/or mechanical bonding of reinforcement to external surfaces of core material) are generally less durable and/or homogenous than a composite formed through a continuous process. For example, the pre-preg material may easily be peeled and removed from the thermoplastic core material as a result of lamination and mechanical bonding processes. Furthermore, a continuous process is generally faster and more cost effective than a discontinuous, batch or, intermittent process. In some embodiments, the composite material formed through the continuous process described above may then be patterned and/or modified using one or more discontinuous processes in order to form a desired structural component.

It will be appreciated that various modifications and changes may be made without departing from the scope of the described technology. Such modifications and changes are intended to fall within the scope of the embodiments that are described. It will also be appreciated by those of skill in the art that features included in one embodiment are interchangeable with other embodiments; and that one or more features from a depicted embodiment can be included with other depicted embodiments in any combination. Any of the various components described herein and/or depicted in the figures may be combined, interchanged, or excluded from other embodiments.

What is claimed is:

1. A method for manufacturing a reinforced composite body, the method comprising:
softening or melting one or more thermoplastic resins to provide a melt stream;
introducing one or more pre-impregnated materials into the melt stream of the one or more thermoplastic resins; and
co-extruding the melt stream of one or more thermoplastic resins and one or more pre-impregnated materials through one or more dies to form the reinforced composite body;
wherein the co-extruding occurs under conditions of sufficient pressure and temperature to cause the one or more pre-impregnated materials to bond or comingle with the one or more thermoplastic resins causing the one or more pre-impregnated materials and one or more thermoplastic resins to form the reinforced composite body.

2. The method of claim 1, wherein the one or more pre-impregnated materials are combined with the one or more thermoplastic resins such that the reinforced composite body formed therefrom will have structural properties substantially greater than those possible with the one or more thermoplastic resins without the addition of the one or more pre-impregnated materials.

3. The method of claim 1, wherein the position at which the one or more pre-impregnated materials are introduced is based on structural design requirements of the reinforced composite body to impart properties for the specific end use of the reinforced composite body.

4. The method of claim 1, wherein the one or more pre-impregnated materials include reinforcing fibers oriented in multiple directions.

5. The method of claim 1, wherein the one or more pre-impregnated materials including a binding material comprising one or more thermoplastic resins.

6. The method of claim 1, wherein the one or more pre-impregnated materials including a binding material comprising one or more thermosets.

7. A method of manufacturing a reinforced composite body, the method comprising:
melting a thermoplastic resin sheet to form a melt stream;
forming a structural component including structural features from at least the melted thermoplastic resin sheet;
introducing one or more pre-impregnated materials; and
reinforcing the structural component with the one or more pre-impregnated materials,
wherein the pre-impregnated material includes a binding material and a plurality of reinforcing fibers, and
wherein the one or more pre-impregnated materials and the structural component are combined to form a substantially homogenous reinforced composite.

8. The method of claim 7, wherein reinforcing the structural component comprises melting at least a portion of the one or more pre-impregnated materials by applying heat or pressure in a continuous extrusion process.

9. The method of claim 7, wherein forming the structural component comprises extruding the melt stream through a die to form the structural features.

10. The method of claim 9, wherein the one or more pre-impregnated materials are introduced to the melt stream before the melt stream is extruded through the die, and wherein the one or more pre-impregnated materials and the melt stream are co-extruded through the die.

11. The method of claim 9, wherein the one or more pre-impregnated materials are introduced to the structural component following extrusion of the melt stream through the die.

12. The method of claim 7, wherein the binding material and the thermoplastic resin sheet are formed of the same material.

13. The method of claim 7, wherein the melt stream melts at least a portion of the binding material of the pre-impregnated material.

14. The method of claim 7, further comprising forming a plurality of melt streams, and wherein the pre-impregnated material is introduced to the plurality of melt streams.

15. The method of claim 7, wherein the pre-impregnated material may be positioned in different areas of a cross-section of the reinforced composite.

16. A reinforced composite comprising:
a structural component including structural features;
a pre-impregnated material comprising a binding material and a plurality of fibers,
wherein pre-impregnated material and the structural component form a substantially homogenous reinforced composite.

17. The reinforced composite of claim 16, wherein the binding material comprises thermoplastic resin.

18. The reinforced composite of claim 16, wherein the structural component is formed from a thermoplastic resin sheet, and wherein the binding material and the thermoplastic resin sheet are formed of the same material.

19. The reinforced composite of claim 16, wherein the pre-impregnated material is on at least two surfaces of the structural component.

20. The reinforced composite of claim 16, further comprising a thermoplastic external surface.
